(19) United States
(12) Patent Application Publication
(10) Pub. No.: US 2015/0302488 A1
(43) Pub. Date: Oct. 22, 2015

(54) SYSTEM AND METHOD FOR AUTOMATED PROPERTY VAULATION UTILIZING USER ACTIVITY TRACKING INFORMATION

(71) Applicant: ZipRealty LLC, Emeryville, CA (US)

(72) Inventors: James Duncan Wilson, Lafayette, CA (US); Michael Davis, Pleasant Hill, CA (US); Chandrashekhar Elisetty Muni, Fremont, CA (US)

(21) Appl. No.: 14/646,125

(22) PCT Filed: Nov. 21, 2012
(86) PCT No.: PCT/US12/66383

§ 371 Date: May 20, 2015

(51) Int. Cl. G06Q 30/02; G06F 17/30

(52) U.S. Cl. CPC G06Q 30/0278; G06F 17/30241; G06F 17/30876; G06Q 50/16

(57) ABSTRACT

A system, computer-readable storage medium storing at least one program, and computer-implemented method for automated property valuations utilizing user activity tracking information is provided. User activity associated with a real estate website is tracked and stored. User activity is aggregated and a weighted value is assigned to each activity. A property valuation for a particular property is determined based on the aggregated user activity.

### TECHNICAL FIELD

This application relates generally to data processing within a network-based system, and more specifically to systems and methods to provide an automated real estate property valuation based on user activity tracking information.

### BACKGROUND

Appraisers, investment professionals, and lending institutions may use an automated valuation model (AVM) in their analysis of real estate. AVMs provide valuations for real estate property using mathematical modeling combined with information found on public and private property listing databases. Traditional AVMs use historic information from the sales of comparable properties to provide a present market value for a particular real estate property. However, such valuations fail to consider additional factors that may provide an indication of the actual present or future value of the property.

Due to the myopic nature of the information used by traditional AVMs such valuations often only provide an indication of the value of a particular real estate property at a previous time.

Furthermore, traditional AVM based valuation tools are often limited in availability and distribution to only appraisers, investment professionals, and lending institutions. This leaves homeowners and others in the real estate market without a reliable indication of the true value of a real estate property.

### BRIEF DESCRIPTION OF THE DRAWINGS

Some embodiments are illustrated by way of example and not limitation in the figures of the accompanying drawings in which:

FIG. 1 is a block diagram illustrating an abstract view of a network-based system for providing an automated real estate property valuation utilizing user activity tracking information, according to an example embodiment.

FIG. 2 is a block diagram illustrating an architectural view of a network-based system for providing an automated real estate property valuation utilizing user activity tracking information, according to an example embodiment.

FIG. 3A is a high-level entity-relationship diagram, illustrating various tables that may be maintained within a databases of the network-based system, according to an example embodiment.

FIG. 3B is a block diagram illustrating an example table and entries of a database of the network-based system, according to an example embodiment.

FIG. 3C is a block diagram illustrating an example table and entries of a database of the network-based system, according to an example embodiment.

FIG. 3D is a block diagram illustrating an example table and entries of a database of the network-based system, according to an example embodiment.

FIG. 4 is flowchart illustrating a method for determining an automated real estate property valuation utilizing user activity tracking information, according to an example embodiment.

FIG. 5 is a flowchart illustrating a method of providing a valuation adjustment factor for a particular property, according to an example embodiment.

FIG. 6 is an interface diagram illustrating a portion of an example user interface displaying a property search query using geographic area as a parameter, according to an example embodiment.

FIG. 7 is an interface diagram illustrating a portion of an example user interface displaying a property search query using property attributes as a parameter, according to an example embodiment.

FIG. 8 is an interface diagram illustrating a portion of an example user interface displaying a property listing page, according to an example embodiment.

FIG. 9 is an interface diagram illustrating a portion of an example user interface displaying a mobile geopositional property search query result page, according to an example embodiment.

FIG. 10 is an interface diagram illustrating a portion of an example user interface displaying a valuation request page, according to an example embodiment.

FIG. 11 is an interface diagram illustrating a portion of an example user interface displaying a valuation for a particular property, according to an example embodiment.

FIG. 12 is a block diagram illustrating a mobile device, according to an example embodiment.

FIG. 13 is a diagrammatic representation of a machine in the example form of a computer system within which a set of instructions for causing the machine to perform any one or more of the methodologies discussed herein may be executed.

### DETAILED DESCRIPTION

Reference will now be made to specific embodiments, examples of which are illustrated in the accompanying drawings. It will be understood that the accompanying description is not intended to limit the scope of the claims to the described embodiments. In the following description, specific details are set forth in order to provide a thorough understanding of the subject matter. Embodiments may be practiced without some or all of these specific details. In addition, well known features may not have been described in detail to avoid unnecessarily obscuring the subject matter.

In accordance with the present disclosure, the components, process steps, and/or data structures may be implemented using various types of operating systems, programming languages, computing platforms, computer programs, and/or general purpose machines. In addition, those of ordinary skill in the art will recognize that devices of a less general purpose or nature, such as hardwired devices, field programmable gate arrays (FPGAs), application specific integrated circuits (ASICs), or the like, may also be used without departing from the scope and spirit of the concepts disclosed herein. Embodiments may also be tangibly embodied as a set of computer instructions stored on a computer readable medium, such as a memory device.

Those in the market to buy real estate often browse real estate websites (e.g., ZIPREALTY.COM) to search for real estate properties. Real estate websites may maintain online property listings for a variety of property types and styles in a variety of geographic locations. Each online real estate property listing may have a dedicated web page (or set of web pages) on the real estate website to provide information for each property. This information may include pictures, floor plans, and other details about the property. Online property listings may also provide a user with the ability to print the listing, save the listing for later viewing, share the listings with another, request a visit to the property, request more information about the property and get directions to the property.

Real estate websites may provide users with the ability to quickly filter, sort, and search through property listings using one or more search parameters. In one embodiment, a user may limit a property search query based on the geographic area in which the property is located. In another embodiment, a user may limit a property search query based on certain attributes of the property. In other embodiments, a real estate website may also provide a mobile version of their website or a mobile application to provide enhanced search functionality to a mobile client device of a user.

According to example embodiments, user activity on a real estate website is tracked and a valuation for a particular piece of real estate is provided based on the information from user activity tracking. User activity on a real estate website may provide a more accurate indication of the actual current or future value of a property. The user activity that is tracked by the system may include any one of the functionalities provided by the real estate website.

A valuation for a particular real estate property may be determined based on information from tracked user activity. For purposes of the present disclosure and the claims, the concepts “property,” and “real estate property” shall be synonymous and may refer to any house or building and the land on which they sit or a piece of undeveloped land including any natural resources (e.g. crops, minerals, or water) located on the land. In one embodiment, a valuation may provide the present market value of a particular property. In another embodiment, a valuation may provide a future, predicted or anticipated market value of a particular property at a specific future date.

A valuation may be determined based on aggregate values of user activity such as total number of times a particular geographic area was searched, a total number of times a particular attribute was used as a search parameter, or the relative popularity of a particular online property listing. Each of the various types of tracked user activities may be assigned a relative weight in determining the valuation. In some embodiments, the user activity data is used as an input into the calculation of the valuation. In other embodiments, the user activity is used to provide an adjustment factor for a predetermined valuation in order to produce the valuation for the particular property.

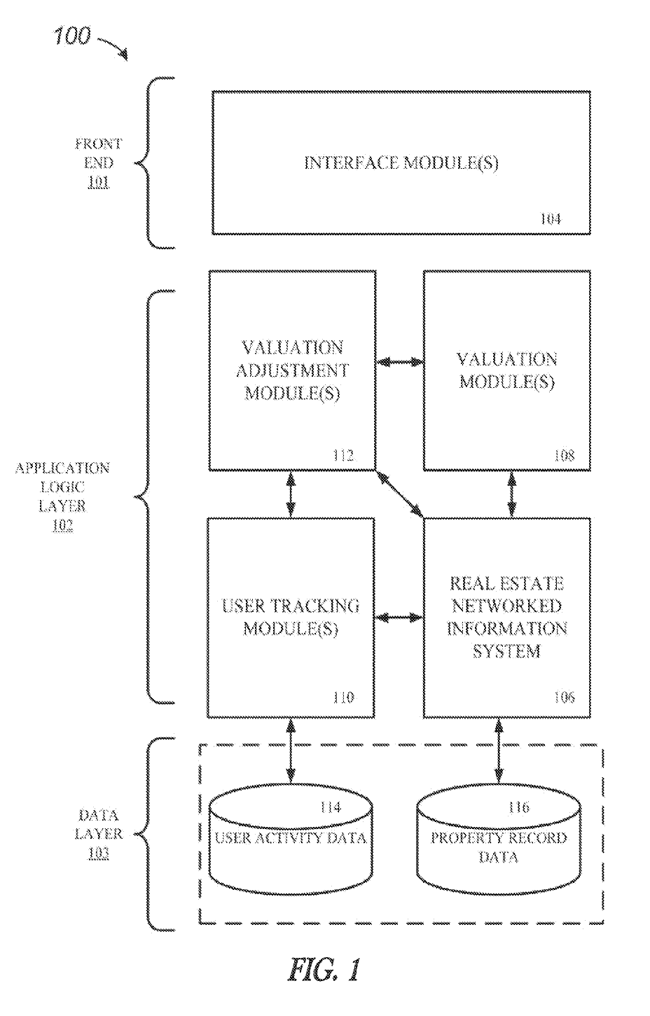

FIG. 1 is a block diagram illustrating an abstract view of various functional components of an example system 100 for providing an automated property valuation utilizing user tracking information, according to an example embodiment. As shown in FIG. 1, the system 100 is generally based on a three-tiered architecture, consisting of a front-end layer 101, application logic layer 102, and a data layer 103. As is understood by those skilled in the relevant computer and Internet-related arts, each module or engine shown in FIG. 1 represents a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 1. However, various additional functional modules and engines may be used with system 100 to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, the inventive subject matter is by no means limited to such an architecture.

As shown in FIG. 1, the front end layer 101 includes an interface module (e.g., a web server and application program interface (API)) 104, which receives requests from various client-computing devices of various users, and communicates appropriate responses to the requesting client devices. For example, the interface module(s) 104 may receive requests in the form of Hypertext Transport Protocol (HTTP) requests, or other web-based, API requests.

As illustrated in FIG. 1, the interface modules 104 may include an API module (not shown), which is coupled to and provides programmatic interfaces to one or more of each of the real estate networked information system 106, valuation modules 108, user tracking modules 110, and valuation adjustment modules 112. The real estate networked information system 106, valuation modules 108, user tracking modules 110, and valuation adjustment modules 112 are, in turn, coupled via the API module to one or more user activity databases 114 and property record databases 116.

The application logic layer 101 of the system 100 may include a server(s) that includes at least one processing device configured to implement at least the respective methods discussed herein. In some embodiments, the system 100 is implemented as its own application server module(s) such that it operates as a stand-alone application. However, in other embodiments, the system 100 may be implemented as a service that operates in conjunction and is integrated with a third party AVM system or third party property information system (e.g., listing service). The interface modules 104 may include or have an associated publicly available API module that enables third-party applications to invoke the functionality of system 100.

As illustrated by FIG. 1, the system 100 may include a user tracking module 110, which is communicatively coupled to real estate networked information system 106. The user tracking module 110 may be a hardware implemented module or software executed by general purpose or special purpose hardware or instructions stored on a computer readable medium that is operative to track the activity of users on a real estate networked information system 106 (e.g., a real estate website).

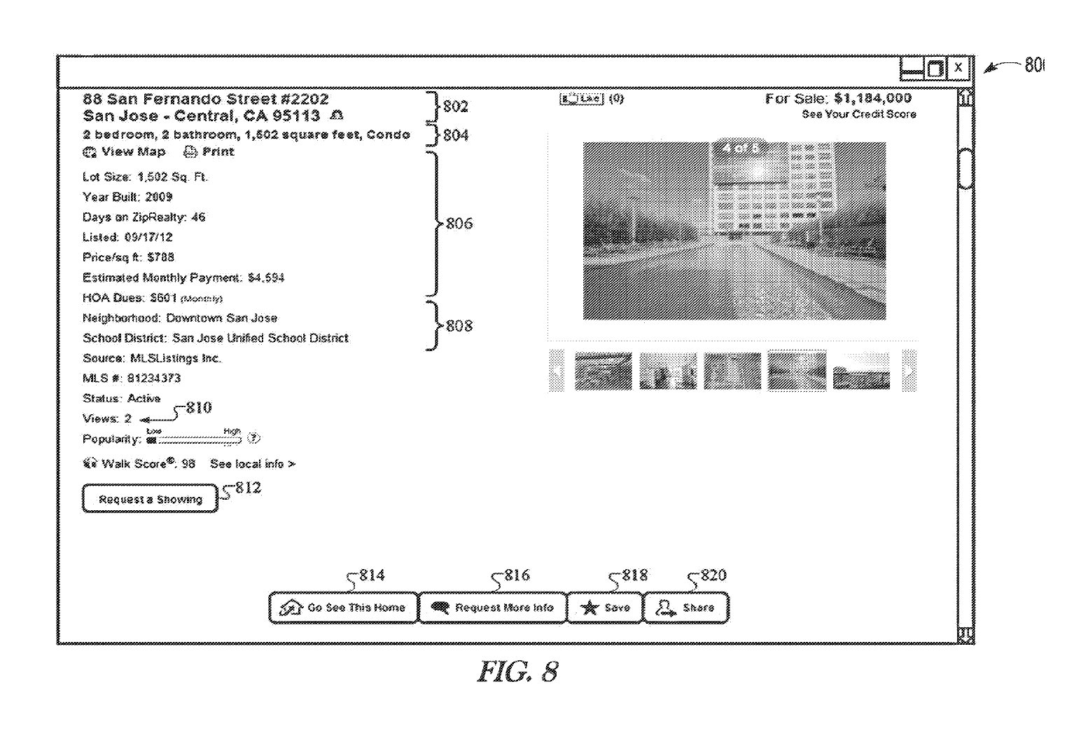

In one embodiment, the real estate networked information system 106 may be a real estate website that hosts information for real estate properties, such as the information stored in the property record database 116. In another embodiment, the real estate networked information system 106 may be a real estate website that also maintains several listings of properties for sale. Each online real estate property listing may have a dedicated web page (or a set of web pages), such as the listing illustrated in FIG. 8, which is discussed in more detail below, to provide information for each piece of property. This information may include pictures, floor plans, a geographic area in which the property is located and other attributes of the property (e.g., price, size, year built, date listed, price per square foot, number of bedrooms, number of bathrooms, and property type). Online property listings may also provide a user with the ability to print the listing, save the listing for later viewing, share the listings with another, request a visit to the property, request more information about the property and get directions to the property.

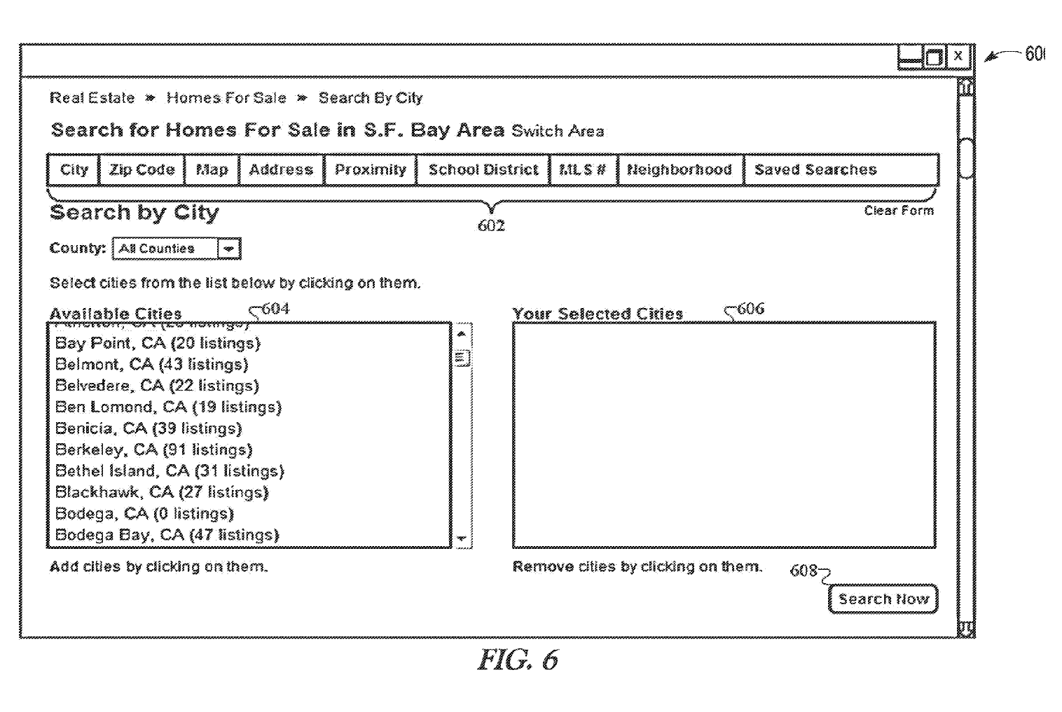

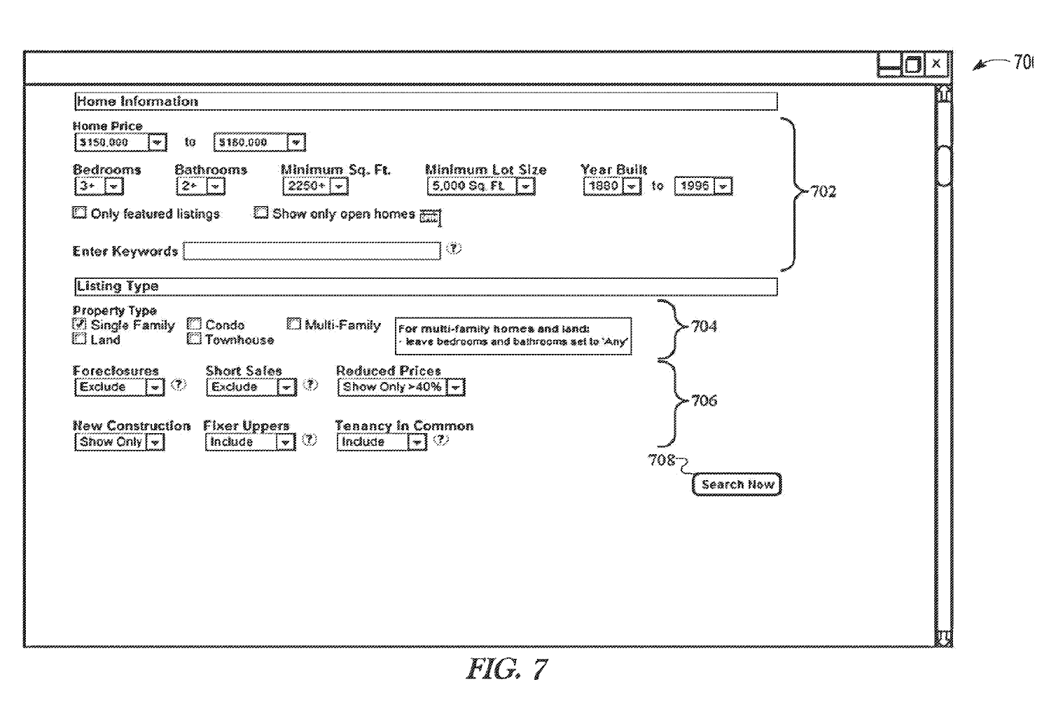

The real estate networked information system 106 may provide users with the ability to quickly filter, sort, and search through property listings using one or more search parameters. Example property search queries will be discussed in greater detail below in reference to FIGS. 6 and 7. In one embodiment, the real estate networked information system 106 may enable a user may to limit a property search query based on the geographic area in which the property is located. As referenced above, the geographic area in which the property is located may be maintained on each property listing page. A geographic area search may, for example, limit the search to property within a particular city, neighborhood, subdivision, postal code, or school district.

In another embodiment, the real estate networked information system 106 may enable a user to limit a property search query based on certain attributes of the property. As referenced above, these attributes may be maintained on each property listing page. Attributes of a property may, by way of non-limiting example, include a property type (e.g., single family house, multi-family house, condo, land, or apartment), a size (e.g., square footage), a number of bedrooms, a number of bathrooms, an exact price, a price range, a price decile (e.g., “third decile in market”), a year built, a date listed, a number of days on the market, or a transaction type (e.g., foreclosure, short sale, new construction, tenancy in common, or fixer upper).

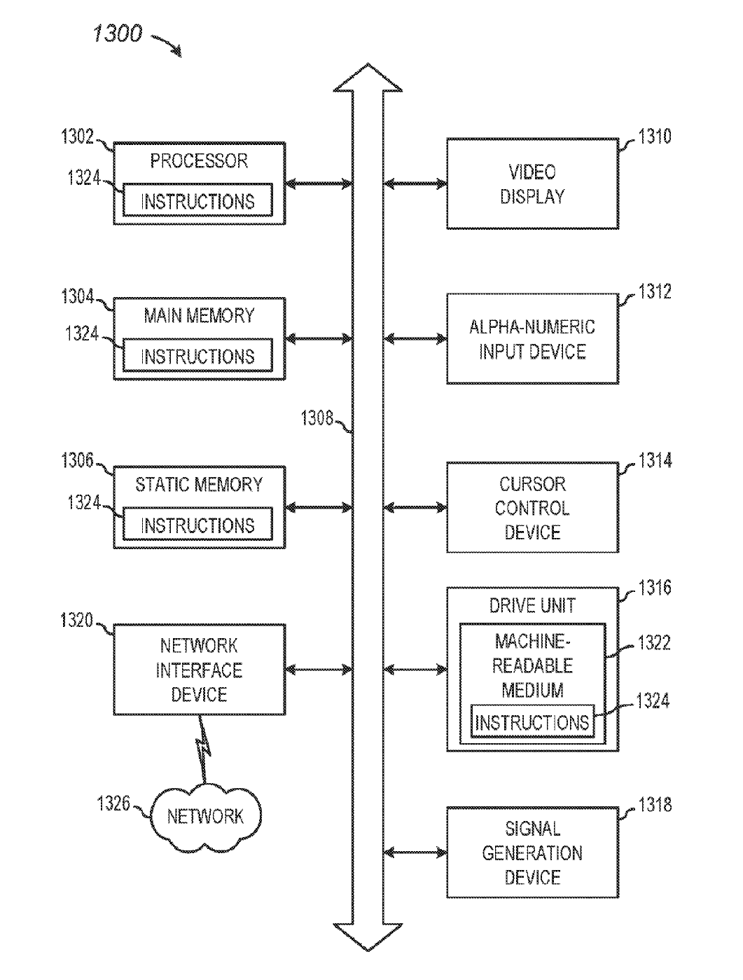

The real estate networked information system 106 may include a mobile real estate website or a mobile application, which provides enhanced search functionality to a mobile client device of a user, such as the mobile device 1200 discussed in further detail below in reference to FIG. 12. In some embodiments, a real estate networked information system 106 may utilize the Global Positioning System (GPS) functionality of a mobile device to provide a user the ability to perform a geopositional property search query. A geopositional property search query may allow a user to perform a property search query, as discussed above, for property listings within a specified distance from the location of the user.

In another embodiment, the real estate networked information system 106 may utilize a camera of a mobile client device, such as the mobile device 1200, combined with existing image-recognition and geopositioning techniques to provide the user with an image-recognition based property search query. An image-recognition based property search query may identify a property from an image and provide the user with the corresponding online property listing. For example, the real estate networked information system 106 may receive an image of a particular property from a client device of a user and, based on the recognition of the particular property, the real estate networked information system 106 may provide the user with the corresponding property listing for the particular property. In another example, the real estate networked information system 106 may receive an image of a real estate sign associated with a particular property having a unique identifier (e.g., Quick Response (QR) code or bar code) identifying the particular property. In this example, the real estate networked information system 106 may provide the user with the property listing corresponding to the property based on recognition of the unique identifier.

The user tracking module 110 may track several types of user activity, which are discussed above with respect to the functionalities of the real estate networked information system 106. The user tracking module 110 may track user activity for each user of the real estate networked information system 106 with respect to the functionalities discussed above. User activity may, for example, include performing a property search query using location or attribute parameters, viewing an online web page for a property listing, printing a property listing, saving a listing for later viewing, sharing a listing with another, requesting a visit to a property, requesting more information about a property, requesting directions to a property, performing a geopositional property search query, performing an image-recognition based property search query or any other actions a user may take on a real estate networked information system 106.

The user activity information is aggregated by the user tracking module 110 to determine a total value for each type of user activity. For example, the user tracking module 110 may track each use of a particular property attribute used in a property search query. In this example, the valuation module 108 may determine a total aggregate value for the use of that particular attribute in search results. The aggregate value determined by the user tracking module 110 may be stored in the user activity database 114.

As illustrated in FIG. 1, the user tracking module(s) 110 may be communicatively coupled to one or more valuation adjustment modules 112. A valuation adjustment module 112 may be a hardware implemented module or software executed by general purpose or special purpose hardware or instructions stored on a computer readable medium that is operative to determine a valuation adjustment factor for a particular property.

Generally, the valuation adjustment module 112 takes as input parameters several pieces of information related to user activity from one or more user tracking modules 110. In some embodiments, the valuation adjustment module 112 may also be communicatively coupled to a user activity databases 114 and a property record databases 116. In this embodiment, the valuation adjustment module 112 may analyze information obtained from the user tracking module 110, and stored in the databases 114 and 116 to determine a valuation adjustment factor for a particular property.

The valuation adjustment module 112 may assign a weight to each type of user activity. The weight of each type of user activity may indicate the relative importance of each activity in providing an accurate property valuation. The weight assigned to each particular type of user activity may vary with time as subsequent user activity is tracked and stored. In one embodiment, the relative importance of each activity may be determined based on a predictive model that is iteratively refined based on the accuracy of previous valuations based on similar tracked user activity information. In other embodiments, the valuation adjustment module 112 may assign a weighted value to each activity based on the frequency of each type of user activity tracked by the user tracking module 110. In another embodiment, the relative weight of each type of user activity may be based on correlations between different types of user activity. In yet another embodiment, the valuation adjustment module 112 may assign the weight of each type of user activity based on aggregate value exceeding a predetermined threshold level.

The valuation adjustment module 112 may also determine the popularity of a particular online property listing based on user activity. The popularity may be represented as a popularity score or as an additional weighted value. The determination of the popularity of a particular online listing may, for example, be based on a number of views of the property listing page, an aggregate time spent by users viewing the property listing, a number of requests to view the particular property, a number of times the particular property has been saved by users, a number of times the property listing has been shared, a number of times directions to the property have been requested, and a number of times the property listing has been printed.

The valuation adjustment module 112 may calculate a valuation adjustment factor based on a combination of the aggregate value of each type of user activity and the respective weighted value of each. In some embodiments, the weight of each type of user activity may be a multiplier that may be used in combination with the aggregate value of each type of user activity to calculate a valuation adjustment factor. In other embodiments, the valuation adjustment factor calculation may also be based on the popularity of a particular online property listing.

As illustrated in FIG. 1, the valuation adjustment modules 112 may be communicatively coupled to one or more valuation modules 108. A valuation module 108 may be a hardware implemented module or software executed by general purpose or special purpose hardware or instructions stored on a computer readable medium that is operative to calculate a valuation for a particular property. In some embodiments, the valuation may be the present value of a particular property. In another embodiment, the valuation may be the value of a particular property at specified future date.

The valuation module 108 may calculate the value of a particular property based in part on an analysis of the sales of comparable properties. The valuation module 108 may also calculate the value of a particular property based on prior surveyor valuations, local historical housing price trends, geographic information or attributes of the property. In some embodiments, the valuation module 108 may utilize a proprietary traditional AVM system in the determination of the value for a particular property. In another embodiment, the valuation module 108 may utilize the functionality of a third party AVM system, via API of the interface module 104, in the determination of the value of a particular property.

In one embodiment, the determination of a valuation for a particular property may include a calculation of a preliminary value of a particular property, based on the considerations referenced above, and a subsequent adjustment to the valuation based on the adjustment factor determined by the valuation adjustment module 112 to calculate a final valuation for the particular property. In this embodiment, the adjustment may be an increase or a decrease in the value. In another embodiment, the valuation module 108 may use the adjustment factor determined by the valuation adjustment module 112 as an additional native input to determination of the valuation of a particular property.

As illustrated in FIG. 1, the data layer includes multiple databases, including one or more property record databases 116, which may store a record for one or more properties maintained by a real estate networked information system 106. Each record may include an identifier, an address, and other information pertaining to one or more real estate properties. This information may be maintained for properties that are currently on the market and listed by real estate networked information system 106 or by a third party server (not shown). The property record database 116 may also include information for other properties that are not currently listed by a listing service and/or are not on the market.

The information maintained for each property may include geographic area location information. Geographic area information may, for example, include a state, a city, a postal code, a neighborhood, a county, a school district, or a metropolitan area.

The property record database 116 may also include specific attributes of each property including, for example, a property type (e.g., single family house, multi-family house, condo, land, or apartment), a property size (e.g., square footage), a number of bedrooms, a number of bathrooms, a price, a year built, a date listed, a number of days on the market, a transaction type (e.g., new, resale, standard, foreclosure, short sale, tenancy in common, or fixer upper).

In one embodiment, property record information for a particular property stored in the databases 114 may be obtained from a user through interface module 104. In another embodiment, property record information for a particular property stored in the databases 116 may be obtained via the API module from public and private (e.g., Multiple Listing Service (MLS)) property listing databases.

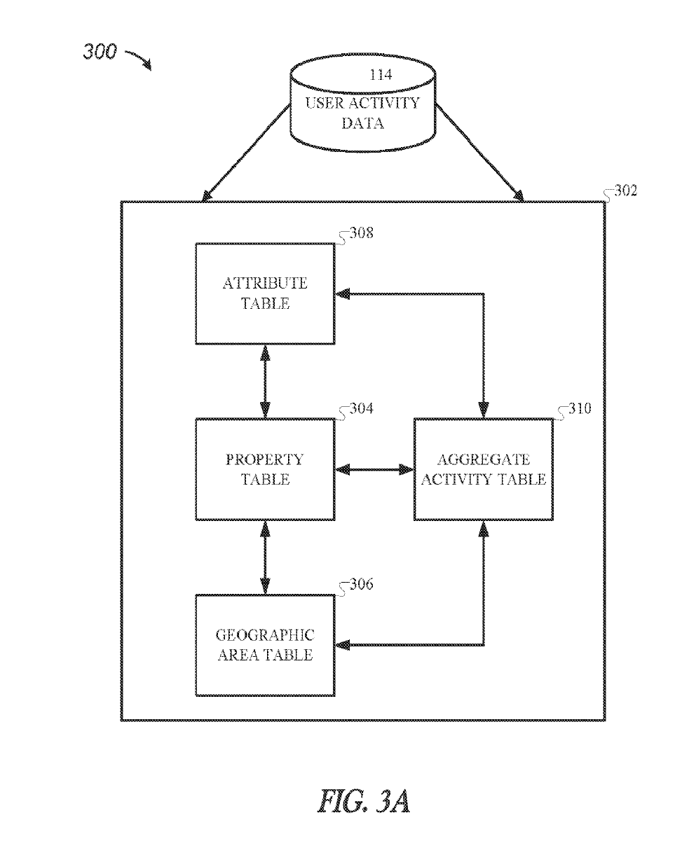

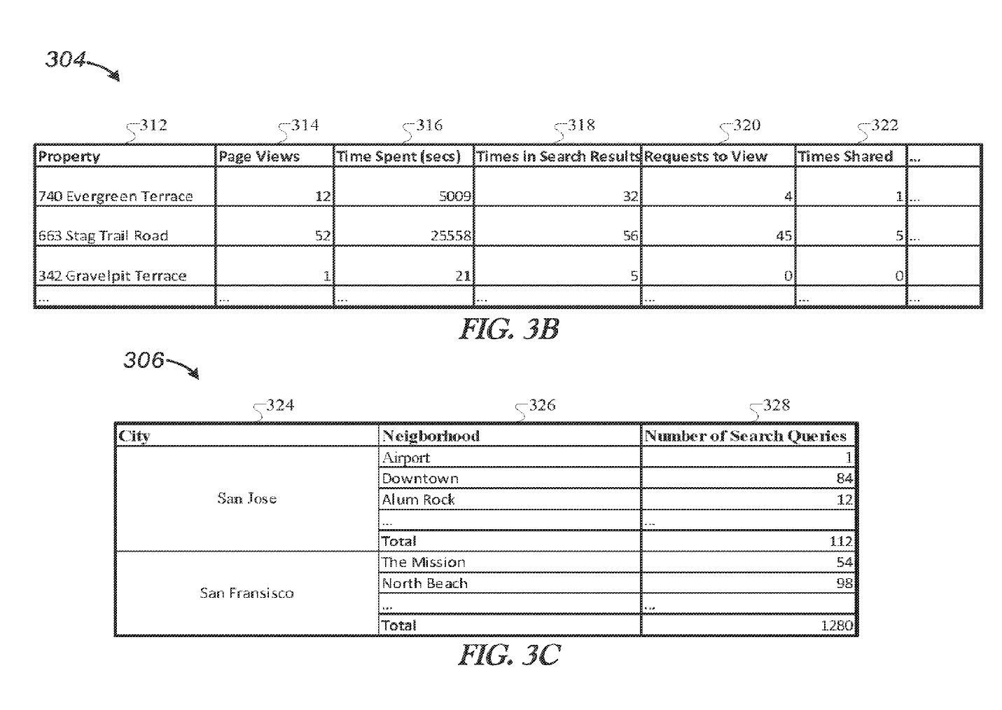

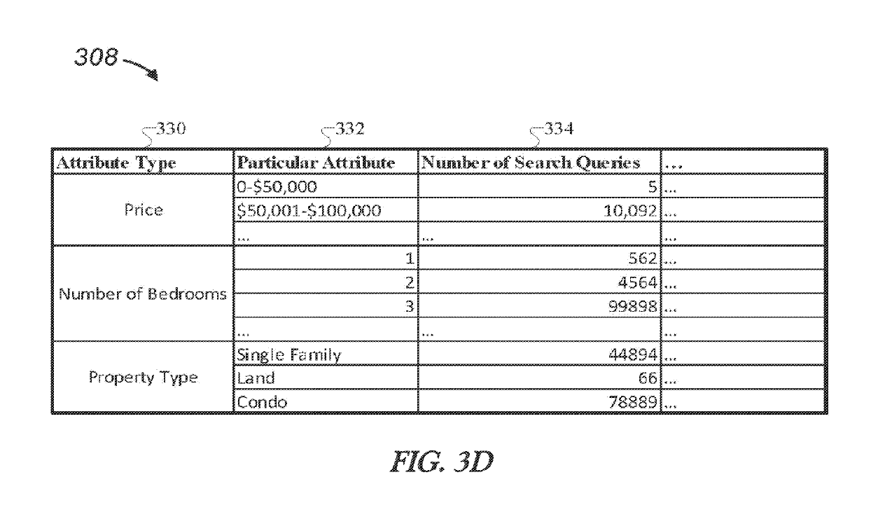

As shown in FIG. 1, the data layer 103 also includes a user activity database 114, which may store the user activity information retrieved by the user tracking module 110. Examples of tables stored in the user activity database 114 will be discussed in greater detail below in reference to FIG. 3A, 3B, 3C, and 3D.

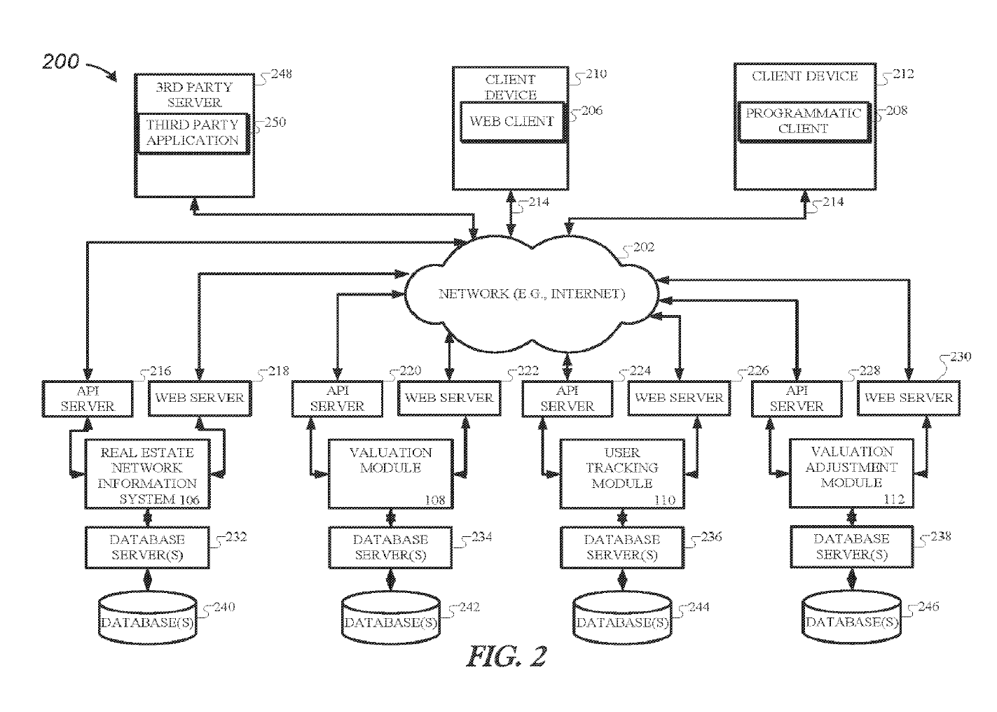

FIG. 2 is a block diagram illustrating an architectural view of a networked system 200, according to an alternative embodiment, having a client-server architecture configured for exchanging data over a network. The networked system 200 provides server-side functionality, via a network 202 (e.g., the Internet or Wide Area Network (WAN)), for each real estate networked information system 106, valuation module 108, user tracking module 110, and valuation adjustment module 112 to one or more clients. For example, FIG. 2 illustrates a web client 206, and a programmatic client 208 executing on respective client device 210 and 212.

The client devices 210 and 212 may be executing conventional web browser applications, or applications that have been developed for a specific platform to include any of a wide variety of mobile devices and operating systems. Client devices 210 and 212 represent example devices that can be utilized by a user to perform various activities associated with a real estate networked information system 106, such as a real estate website. The client devices 210 and 212 may be any of a variety of types of devices (for example, a personal computer, a laptop computer, a cellular telephone, a personal digital assistant (PDA), a Personal Navigation Device (PND), a handheld computer, a tablet computer, a notebook computer, or other type of movable device). The client devices 210 and 212 may interface via a connection 214 with a communication network 202. Depending on the form of the client devices 210 and 212, any of a variety of types of connections 214 and communication networks 202 may be used.

For example, the connection 214 may be a Code Division Multiple Access (CDMA) connection, a Global System for Mobile communications (GSM) connection, or other type of cellular connection. Such connection 214 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, or other data transfer technology (e.g., fourth generation wireless, 4G networks). When such technology is employed, the communication network 202 may include a cellular network that has a plurality of cell sites of overlapping geographic coverage, interconnected by cellular telephone exchanges. These cellular telephone exchanges may be coupled to a network backbone (for example, the public switched telephone network (PSTN), a packet-switched data network, or to other types of networks).

In another example, the connection 214 may be Wireless Fidelity (Wi-Fi, IEEE 802.11x type) connection, a Worldwide Interoperability for Microwave Access (WiMAX) connection, or another type of wireless data connection. In such an embodiment, the communication network 202 may include one or more wireless access points coupled to a local area network (LAN), a wide area network (WAN), the Internet, or other packet-switched data network.

In yet another example, the connection 214 may be a wired connection, for example an Ethernet link, and the communication network may be a LAN, a WAN, the Internet, or other packet-switched data network. Accordingly, a variety of different configurations are expressly contemplated.

Each of the API servers 216, 220, 224, and 228 and each of the web servers 218, 222, 226 and 230 are coupled to, and provide programmatic and web interfaces to, one or more real estate networked information systems 106, valuation modules 108, user tracking modules 110, and valuation adjustment module 112, respectively. The real estate networked information system 106, valuation modules 108, user tracking modules 110, and valuation adjustment modules 112 are, in turn, shown to be respectively coupled to one or more databases servers 232, 234, 236, and 238 that facilitate access to one or more databases 240, 242, 244, and 246, respectively.

Each of the real estate networked information system 106, valuation module 108, user tracking module 110, and valuation adjustment modules 112 may provide a number of functions and services, as discussed above in reference to FIG. 1, to users that may access each individually. While the real estate networked information system 106, valuation modules 108, user tracking modules 110, and valuation adjustment modules 112 are shown in FIG. 2 to be separate and distinct modules, it will be appreciated that, in alternative embodiments, that the real estate networked information system 106, valuation modules 108, user tracking modules 110, and valuation adjustment modules 112 may form one integrated networked system, such as the system illustrated by FIG. 1.

Further, while the system 200 shown in FIG. 2 employs a client-server architecture, the present invention is, of course, not limited to such an architecture, and could equally well find application in a distributed, event-driven, or peer-to-peer architecture system, for example. The real estate networked information system 106, valuation modules 108, user tracking modules 110, and valuation adjustment modules 112 could also be implemented as standalone software programs, which do not necessarily have networking capabilities.

As illustrated by FIG. 2, the web client 206 accesses the real estate networked information system 106 and modules 108, 110, and 112 via the web interface supported by each of the web servers 218, 222, 226 and 230, respectively. Similarly, the programmatic client 208 accesses the various services and functions provided by the real estate networked information system 106 and modules 108, 110, and 112 via the programmatic interface provided by each of the API servers 216, 220, 224, and 228, respectively.

FIG. 2 also illustrates a third party server 248 as having programmatic access to the network 202. The third party server 248 may be coupled via an API server to the communication network 202, for example, via wired or wireless interfaces. The third party server 248 may, utilizing information retrieved from the communication network 202, support one or more third party applications 250. The third party application 250 may be a website hosted by the third party that supports or utilizes one or more functions or features of the real estate networked information system 106 or modules 108, 110, and 112. For example, the third party application 250 may be a third party real estate website that may provide additional user activity information to the valuation adjustment module 112. In another example, the third party website may be a third party AVM system that may obtain an valuation adjustment factor from the valuation adjustment module 112 based on user activity from the real estate networked information system 106. In another example, the third party application 250 may be a third party search engine, from which the user tracking module 110 may obtain additional user tracking information that is pertinent to the value of a particular property.

FIG. 3A is a high-level entity-relationship diagram, illustrating various tables 302 that may be maintained within the user activity databases 114, and that are utilized by the valuation adjustment module 112. A property table 304 contains a record for each real estate property having a property listing page (e.g., interface 800) by the real estate networked information system 106, and may include an identifier, property address or uniform resource locator (URL) corresponding to the property listing page.

The tables 302 may also include a geographic area table 306 in which are maintained a record for each geographic area in which a property listed by the real estate networked information system 106 is located. As referenced above, a geographic area may, for example, include a state, a city, a postal code, a neighborhood, a county, a school district, or a metropolitan area. Each property record within the property table 304 may be linked to one or more geographic area records within the geographic area table 306, so as to associate a particular property listing and one or more geographic areas.

An attribute table 308 contains a record for each property attribute for which a property listed by the real estate networked information system 106 may have. As referenced above, a property attribute may, for example, include a property type (e.g., single family house, multi-family house, condo, land, or apartment), a property size (e.g., square footage), a number of bedrooms, a number of bathrooms, a price, a year built, a date listed, a number of days on the market, a transaction type (e.g., new, resale, standard, foreclosure, foreclosure, short sale, tenancy in common, or fixer upper). Each property record within the property table 304 may be linked to one or more attribute records within the property table 304, so as to associate a particular property listing and one or more property attributes.

As illustrated by FIG. 3A, the tables 302 may include an aggregate activity table 310 which may store a record of aggregated user activity value for each type of user activity that may on the real estate networked information system 106. Aggregate user activity may, for example, include a total number of times a particular property attribute appeared as a parameter in a property search query, a total number of times a particular geographic area appeared as a parameter in a property search query, a total number of page views of an online web page for a property listing, a total number of times a particular property listing was printed, a total number of times a particular property listing was saved for later viewing, a total number of times a particular property listing was shared with another, a total number of requests to view a particular property, a total number of requests for more information about a property, a total number of requests for directions to a particular property, a total number of times a particular property appeared as a result in a geopositional property search query, a total number of times a particular property appeared as a result in image-recognition based property search query. Each aggregated user activity value may be linked to one or more records of the property table 304, geographic area table 306, and attribute table 308, so as to provide an aggregate user activity value for the user activity associated with each type of record.

FIG. 3B provides further details regarding the property table 304, which is shown in FIG. 3A to be maintained within the user activity database 114. As illustrated in FIG. 3B, the property table 304 may, for example, include the data fields 312-322. The data field 312 may identify a particular property by the address in which it is located. The data fields 314-322 illustrate example aggregate user activity fields that may also be maintained in or linked to aggregate activity table 310. Although the property table 304 is illustrated to include the data fields 312-322, it should be appreciated that FIG. 3B is intended for illustrative purposes only and that the property table 304 is not limited to only those fields illustrated therein. Furthermore, in some embodiments, the property table 304 may not include every data field illustrated in FIG. 3B.

FIG. 3C provides further details regarding the geographic area table 306 that is shown in FIG. 3A to be maintained within the user activity database 114. As illustrated in FIG. 3C, the geographic area table 306 may include a data field 324, which may store a record for each city in which a property maintained by real estate networked information system 106 may be located. The geographic area table 306 may also include a data field 326, which may store a record for each neighborhood within each city stored in the data field 324. The data fields 328 illustrates an example aggregated user activity field that may also be maintained in or linked to the aggregate activity table 310. Although the geographic area table 306 is illustrated to include only the data fields 324-328, it should be noted that FIG. 3C is intended for illustrative purposes only and that the geographic area table 306 may not be limited to those fields illustrated therein. Furthermore, in some embodiments, the geographic area table 306 may not include every data field illustrated in FIG. 3C.

FIG. 3D provides further details regarding the attribute table 308 that is shown in FIG. 3A to be maintained within the user activity database 114. As illustrated in FIG. 3D, the attribute table 308 may include a data field 330, which maintains a record of broad attribute types. The attribute table 308 may further include a data field 332, which stores a record of particular attributes within each attribute type of the data field 330. The data fields 334 illustrate an example aggregated user activity value that may also be maintained in or linked to the aggregate activity table 310. Although the attribute table 308 is illustrated to include the data fields 330-334, it should be appreciated that FIG. 3D is intended for illustrative purposes only and that the attribute table 308 is not limited to only those fields illustrated therein. Furthermore, in some embodiments, the attribute table 308 may not include every data field illustrated in FIG. 3D.

### Methods

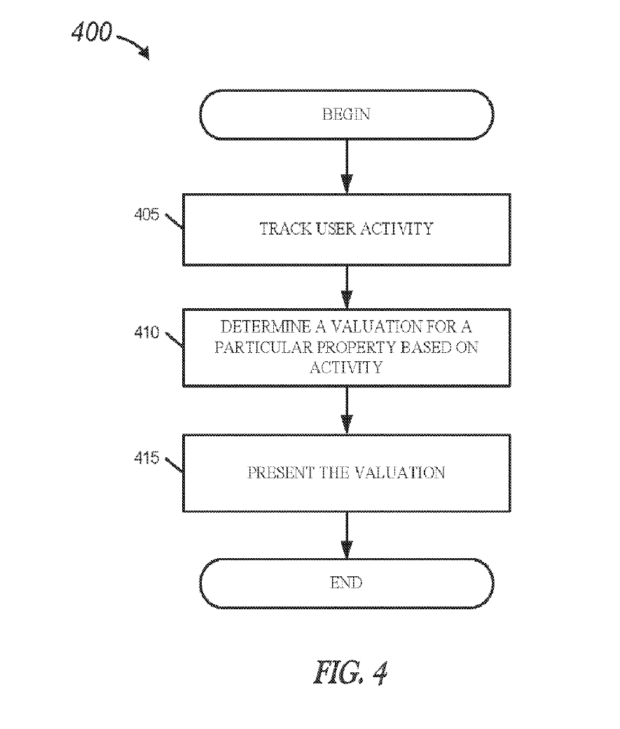

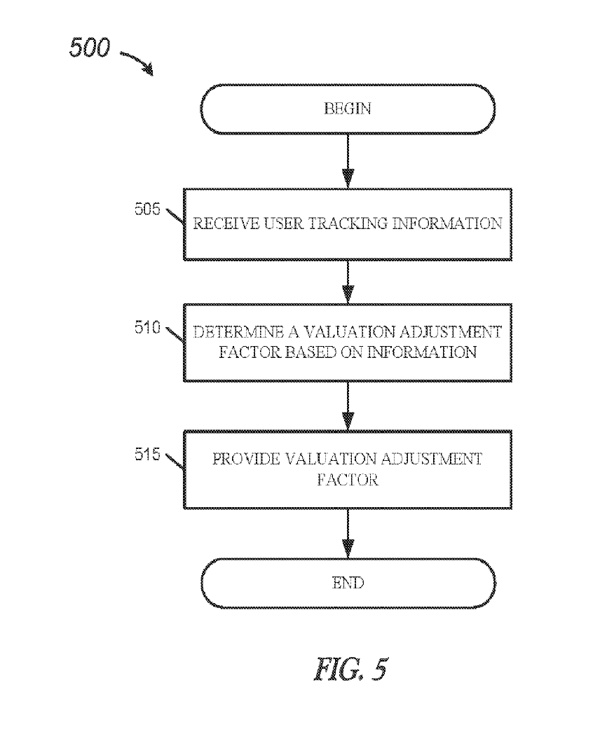

FIG. 4 is flowchart illustrating a method 400 for providing a real estate property valuation utilizing user activity tracking information, according to an example embodiment. At block 405, the user activity of a plurality of users is tracked by the user tracking module 110. The user activity may be related to a real estate networked information system (e.g., real estate networked information system 106). In some embodiments, the networked information system may be a real estate website hosting a plurality of real estate property listings. In another embodiment, the networked information system may be a real estate application for a mobile device (e.g., mobile device 1400).

In one embodiment, the user activity comprises a plurality of types of user activity. In this embodiment, at block 405, the tracking module 110 may additionally determine an aggregate value for each type of user activity and store this information in a database that is assessable by the valuation module 108 and the valuation adjustment module 112.

At block 410, a valuation for a particular property is determined In one embodiment, the determination of the valuation may include a determination by the valuation adjustment module 112 of a valuation adjustment factor based on the user activity tracked by the user tracking module 110. In this embodiment, the valuation adjustment module 112 may first assign a weight to each aggregated value for each type of user activity as determined by user tracking module 110. Additionally, a popularity of an online property listing corresponding to the particular property may be determined Further, a combination of the aggregate value, listing popularity and relative weight of each type of user activity may be used by the valuation adjustment module 112 to calculate the valuation adjustment factor.

In one embodiment, the valuation module 108 may determine the valuation for the particular property at block 410 using the adjustment factor to refine a predetermined valuation for the particular property based on the valuation. In another embodiment, the valuation module 108 may use the valuation adjustment factor in as a native input to the calculation of a valuation for a particular property.

The method 400 may optionally include block 415, in which the valuation is presented. In one embodiment, the presenting of the valuation includes providing display data to display, at a client device, the valuation to a user who requested the valuation of the particular property. The user may, for example, be the owner of the property or an agent of the real estate networked information system 106.

In another embodiment, the valuation may be presented as part of an online property listing corresponding to the particular property, at block 415.

The online property listing may be hosted by the real estate networked information system 106 or a third party server (e.g., third party server 248). In this embodiment, the valuation may be presented in real-time such that the valuation is updated as additional user activity is tracked by the user tracking module 110.

In yet another embodiment, the presentation of the valuation includes providing display data to present the valuation to a real estate sign, at block 415. Such a real estate sign may include display and network capabilities and may be communicatively coupled to the network 202. In this embodiment, the valuation may be presented in real-time such that the valuation changes as additional user activity is tracked by the user tracking module 110. The real estate sign may obtain the valuation, via an API module, directly from the valuation module 108 or from a third party server 248 (real estate networked information system 106).

FIG. 5 is a flowchart illustrating a method 500 of an alternative embodiment of determining a valuation for a particular property, according to an example embodiment. At block 505, user activity tracking information is received directly by the valuation adjustment module 112 from a third party application (e.g., third party application 250).

At block 510, a valuation adjustment factor may be determined by the valuation adjustment module 112. In one embodiment, the step of determining of the valuation adjustment factor may include assigning a weight to each type of user activity received from the third party application 250. In this embodiment, the valuation adjustment module 112 may then calculate a valuation determination factor based on the aggregate value and weighted value for each type of user activity.

At block 515, the valuation adjustment factor may optionally be provided to the third party application 250. In one embodiment, the third party may use the valuation adjustment factor to refine a predetermined valuation for a particular property. In an alternative embodiment, the third party application 250 may use the valuation adjustment factor in the initial determination of a property valuation.

### User Interfaces

FIG. 6 is an interface diagram illustrating a portion of an example user interface 600 displaying a property search query using geographic area as a parameter, according to an example embodiment. The interface 600 includes the geographic area selections 602 to enable a user to narrow a property search query to particular geographic areas. As illustrated in FIG. 6, the geographic area selections 602 include city, zip code, map, address, proximity, school district, MLS number, and neighborhood. In this particular example interface, the user has selected to narrow a property search query to cities located in the “San Francisco Bay Area.” Accordingly, the interface 600 includes a list of selectable available cities 604. A user may select one or more cities to include in the selected cities 606. A user may then perform a property search query limited to those properties located within the selected cities 606 by selecting the button 608.

In some embodiments, upon selection of the button 608, the user tracking module 110 may track the user query and store the information in user activity database 114. Additionally, the user tracking module 110 may track and store the appearance of particular properties in results for property search queries.

FIG. 7 is an interface diagram illustrating a portion of an example user interface 700 displaying a property search query using property attributes as a parameter, according to an example embodiment. The interface 700 includes several property attributes that may be used as a parameter to search, filter, and sort through property listings. As illustrated in FIG. 7, the interface 700 includes several home information attributes 702. In this example, home information attributes 702 include data input fields for “Home Price,” “Bedrooms,” “Bathrooms,” “Minimum Sqr. Ft.,” “Minimum Lot Size,” “Year Built,” and “Keywords.” As illustrated in FIG. 7, interface 700 also includes listing type attributes which include property types 704 and transaction types 706. In this example, the property types 704 include “Single Family,” “Condo,” “Multi-Family,” “Land,” and “Townhouse.” In this example, transaction type attributes 706 includes “Foreclosures,” “Short Sales,” “Reduced Prices,” “New Construction,” “Fixer Uppers,” and “Tenancy in Common ” Accordingly, a user may limit a property search query based on one or more of these attributes by inputting the desired data into the parameters 702, 704, and 706 and selecting button 708. Upon selection of the button 708, the user tracking module 110 may track the user query and store the information in the user activity database 114.

FIG. 8 is an interface diagram illustrating a portion of an example user interface 800 displaying a property listing page, according to an example embodiment. As illustrated by FIG. 8, the user interface 800 includes general property information 802, which provides an identifier of the property. In this example, the general property information 802 includes the address of the property. The interface 800 may also include the general attribute information 804, which includes the number of bedrooms, the number of bathrooms, the size and property type of the property.

As illustrated by FIG. 8, an example interface 800 also includes specific property attributes 806, which may include a lot size, a year built, a number of days listed, a size, and an estimated monthly payment. The example interface 800 also includes geographic area information 808, which may include the neighborhood and school district of the property. Additionally, the user interface 800 may include a number of views 810 corresponding to the number of times the listing page has been viewed by users.

As illustrated in FIG. 8, a property listing page may include a number of features that enable a user to obtain more information about a specific property or share information about the property with others. In particular, a user may be provided the ability to request a showing of the property through selection of the button 812. Also, a user may view the property location on a map by selecting the button 814. The interface 800 may also include the button 816, which provides the user the ability to request additional information about a property not located on the property listing page. Additionally, the user interface 800 includes the button 818, which allows a user to save a particular property listing to a collection of listings to be viewed by the user at a later time. The user interface 800 may also include the button 820, which allows a user to share the property listing with another via email or social network.

The tracking module 110 may track and store a number of user views of each property listing page (e.g. property listing page of interface 800), the time a user spends reviewing a page, and the number of times a particular listing appears in the list of results for a property search query. Additionally, in some embodiments, the user tracking module 110 may track and store each user selection of buttons 812, 814, 816, 818, and 820.

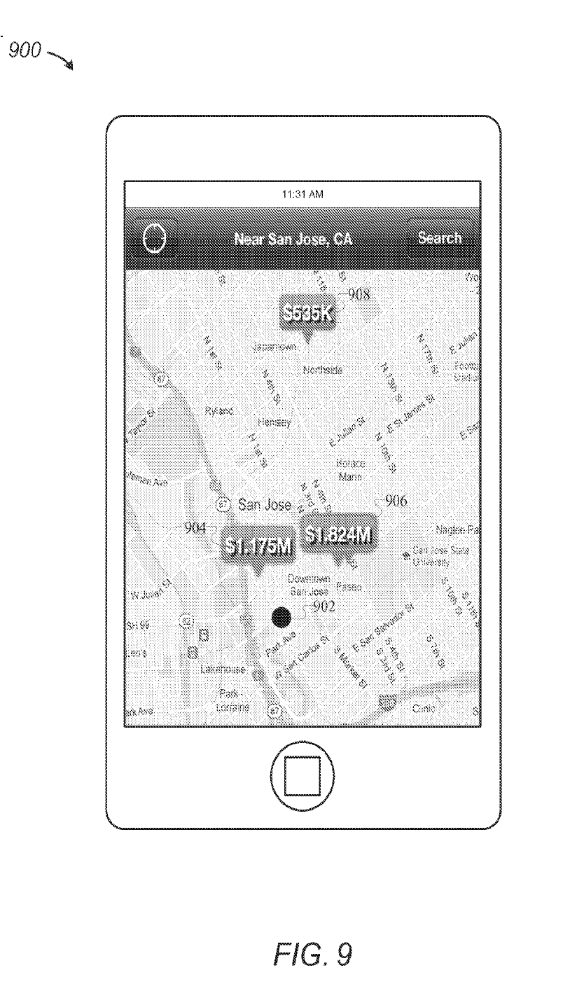

FIG. 9 is an interface diagram illustrating a portion of an example user interface 900 displaying results for a mobile geopositional property search query using a mobile client device (e.g., mobile device 1200), according to an example embodiment. In this example, a user may perform a property search query using similar parameters as those discussed in reference to FIGS. 6 and 7 with the user's location as an additional parameter. In this example, the results for the user's property search query are provided to the device, by the interface module 104 and are displayed as a map including the user location and location of the property results.

As illustrated in FIG. 9, interface 900 includes the user location 902 and the property results 904, 906, and 908. The property results 904, 906, and 908 correspond to properties that match a property search query submitted by the user. In some embodiments, the user tracking module 110 may track and store the location (e.g., user location 902) from which a property search query was performed. Additionally, the user tracking module 110 may track and store the appearance of particular properties (e.g., property results 904, 906, and 908) in results for geopositional property search queries.

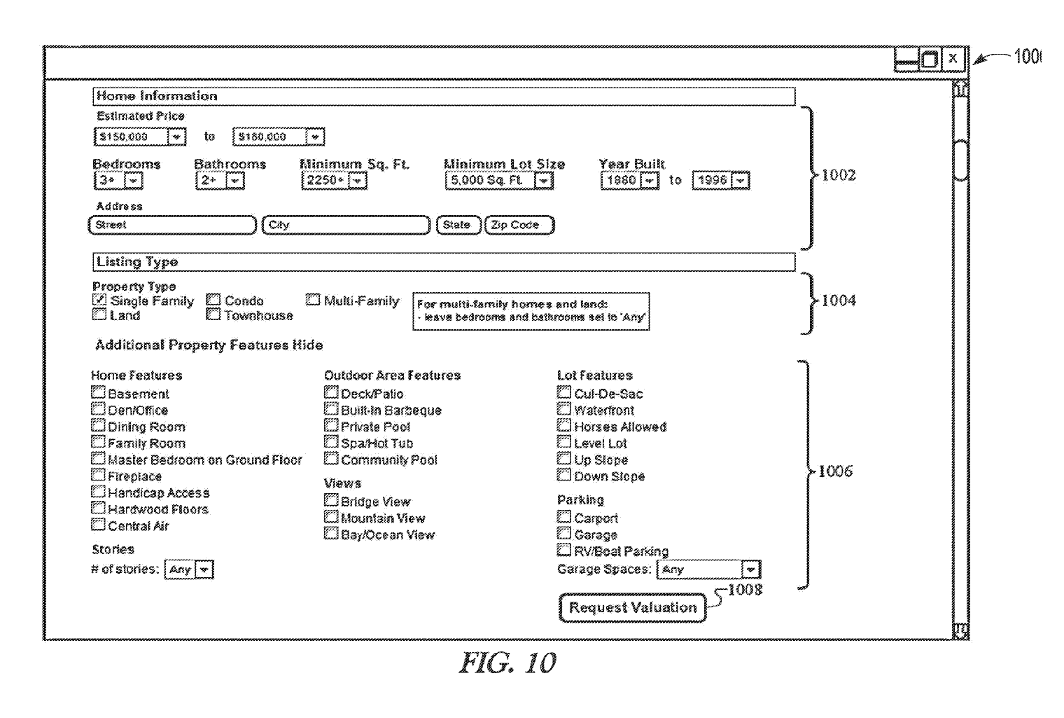

FIG. 10 is an interface diagram illustrating a portion of an example user interface 1000 displaying a valuation request page, according to an example embodiment. In some embodiments, a user may request a valuation for a particular property through, for example, interface 1000. The interface 1000 may include a number of data fields for each of the types of property attributes. As illustrated in FIG. 10, the interface 1000 includes the home information attributes 1002, list type attributes 1004, and additional property attributes 1006. A user may obtain a valuation for a property by filing out each pertinent data field and selecting button 1008.

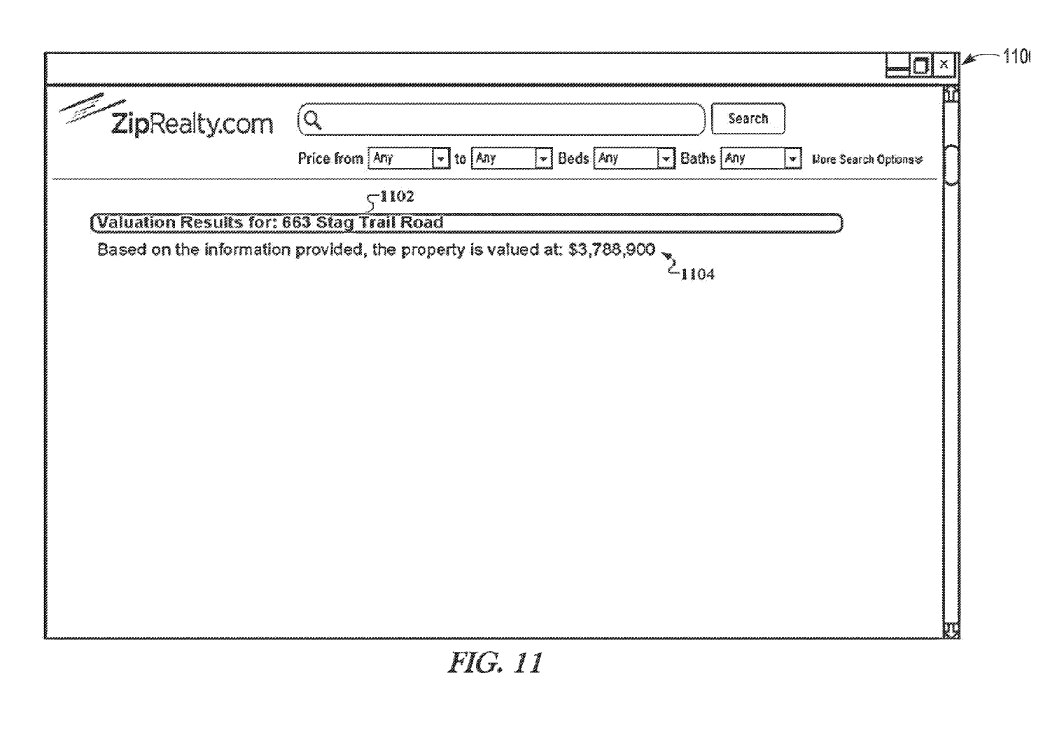

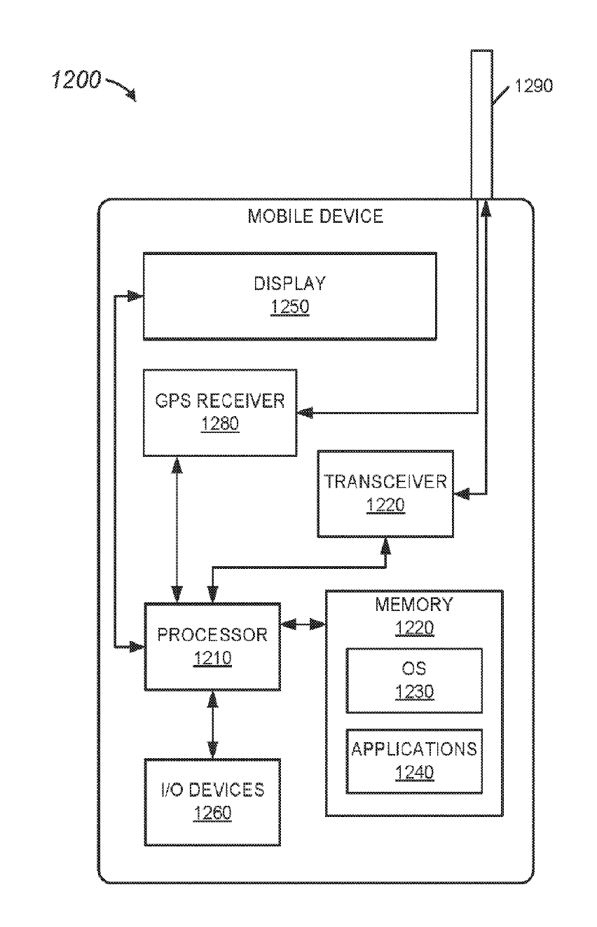

FIG. 11 is an interface diagram illustrating a portion of an example user interface 1100 displaying a valuation for a particular property, according to an example embodiment. The interface module 104 may provide the display of a valuation, as is provided in interface 1100, after a user valuation request, such as that of the interface 1000, has been submitted. As illustrated in FIG. 11, the interface 1100 includes the property identity 1102, which in this case includes the address of the property. The interface 1100 also includes the valuation 1104 for the properties identified by the property identifier 1104. In some embodiments, the valuation 1104 may be for a present market value of the property. In other embodiments, the valuation 1104 may include a market value of the property at a future time specified by the user.

### Example Mobile Device

FIG. 12 is a block diagram illustrating a mobile device 1200, according to an example embodiment. The mobile device 1200 may include a processor 1210. The processor 1210 may be any of a variety of different types of commercially available processors suitable for mobile devices (for example, an XScale architecture microprocessor, a Microprocessor without Interlocked Pipeline Stages (MIPS) architecture processor, or another type of processor). A memory 1220, such as a Random Access Memory (RAM), a Flash memory, or other type of memory, is typically accessible to the processor. The memory 1220 may be adapted to store an operating system (OS) 1230, as well as application programs 1240, such as a mobile location enabled application that may provide location based services to a user. The processor 1210 may be coupled, either directly or via appropriate intermediary hardware, to a display 1250 and to one or more input/output (I/O) devices 1260, such as a keypad, a touch panel sensor, a microphone, and the like. Similarly, in some embodiments, the processor 1210 may be coupled to a transceiver 1220 that interfaces with an antenna 1290. The transceiver 1220 may be configured to both transmit and receive cellular network signals, wireless data signals, or other types of signals via the antenna 1290, depending on the nature of the mobile device 1200. In this manner, the connection 214 with the communication network 202 may be established. Further, in some configurations, a GPS receiver 1280 may also make use of the antenna 1290 to receive GPS signals.

### Modules, Components And Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

### Electronic Apparatus And System

Example embodiments may be implemented in digital electronic circuitry, or in computer hardware, firmware, software, or in combinations of them. Example embodiments may be implemented using a computer program product, for example, a computer program tangibly embodied in an information carrier, for example, in a machine-readable medium for execution by, or to control the operation of, data processing apparatus, for example, a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Machine Architecture and Machine-Readable Medium

FIG. 13 is a block diagram of a machine in the example form of a computer system 1300 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a PDA, a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1300 includes a processor 1302 (e.g., a central processing unit (CPU), a graphics processing unit (GPU) or both), a main memory 1304 and a static memory 1306, which communicate with each other via a bus 1308. The computer system 1300 may further include a video display unit 1310 (e.g., a liquid crystal display (LCD) or a cathode ray tube (CRT)). The computer system 1300 also includes an alphanumeric input device 1312 (e.g., a keyboard), a user interface (UI) navigation device 1314 (e.g., a mouse), a disk drive unit 1316, a signal generation device 1318 (e.g., a speaker) and a network interface device 1320.

### Machine-Readable Medium

The disk drive unit 1316 includes a machine-readable medium 1322 on which is stored one or more sets of instructions and data structures (e.g., software) 1324 embodying or used by any one or more of the methodologies or functions described herein. The instructions 1324 may also reside, completely or at least partially, within the main memory 1304, static memory 1306, and/or within the processor 1302 during execution thereof by the computer system 1300, the main memory 1304 and the processor 1302 also constituting machine-readable media.

While the machine-readable medium 1322 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present disclosure, or that is capable of storing, encoding or carrying data structures used by or associated with such instructions. The term “machine-readable medium” shall accordingly be taken to include, but not be limited to, solid-state memories, and optical and magnetic media. Specific examples of machine-readable media include non-volatile memory, including by way of example, semiconductor memory devices (e.g., Erasable Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks.

### Transmission Medium

The instructions 1324 may further be transmitted or received over a communications network 1326 using a transmission medium. The instructions 1324 may be transmitted using the network interface device 1320 and any one of a number of well-known transfer protocols (e.g., HTTP). Examples of communication networks include a LAN, a WAN, the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” and “third,” and so forth are used merely as labels, and are not intended to impose numerical requirements on their objects.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. A method comprising:
tracking user activity of a plurality of users, the user activity relating to a plurality of property listings hosted by a network information system; and
determining, using one or more processors, a valuation for a particular property based on the tracked user activity of the plurality of users.

2. The method of claim 1, wherein the tracked user activity comprises a plurality of types of user activity and the tracking of user activity includes determining an aggregate value for each type of the plurality of types of user activity.

3. The method of claim 2, wherein the determining of the valuation for the particular property includes assigning a weighted value to each type of the plurality of types of user activity.

4. The method of claim 1, further comprising providing display data to display the valuation for the particular property to a user.

5. The method of claim 1, wherein the determining the valuation for the particular property includes determining a valuation adjustment factor to be used in adjusting a predetermined valuation of the particular property.

6. The method of claim 1, wherein the user activity includes searching the plurality of property listings for a property within a particular geographic area.

7. The method of claim 6, wherein the particular geographic area is a city, a neighborhood, or a metropolitan area.

8. The method of claim 1, wherein the tracked user activity includes searching the plurality of property listings for a property having a particular attribute.

9. The method of claim 8, wherein the particular attribute is price, number of bedrooms, number of bathrooms, size of the property, type of property or type of transaction associated with the property.

10. The method of claim 8, wherein the particular property is a house and the particular attribute is at least one of size of the property, year the property was built, or time that the property has been on the market.

11. The method of claim 1, wherein the tracking of the user activity of the plurality of users includes determining an aggregate number of times a particular property listing of the plurality of property listings appeared in a list of results for a property search query submitted on the real estate website.

12. The method of claim 1, wherein the tracking of the user activity of the plurality of users includes determining a popularity of a particular property listing of the plurality of property listing.

13. The method of claim 12, wherein the determining of the popularity of the particular property listing is based on at least one of a number of views of the property listing, an aggregate time spent by the plurality of users viewing the particular property listing, a number of requests to view the particular property listing, a number of times the particular property listing has been saved by the plurality of users, a number of times the property listing has been shared, a number of times an address corresponding to the particular property listing has been included in driving directions, or a number of times the particular property listing has been printed.

14. The method of claim 1, wherein the user activity is a geopositional search performed on a client device of the user.

15. A system comprising:
a user tracking module to track user activity of a plurality of users, the user activity relating to a plurality of property listings hosted by a network information system; and
a valuation module to determine a valuation for a particular property based on the tracked user activity of the plurality of users.

16. The system of claim 15, wherein the tracked user activity comprises a plurality of types of user activity and the tracking of user activity includes determining an aggregate value for each type of the plurality of types of user activity.

17. The system of claim 16, wherein the determining of the valuation for the particular property includes assigning a weighted value to each type of the plurality of types of user activity.

18. The system of claim 15, wherein the tracked user activity includes searching the plurality of property listings for a property within a particular geographic area and having a particular attribute.

19. A machine-readable medium embodying instructions that, when executed by a machine, cause the machine to perform operations comprising:
receiving user tracking activity information for a plurality of users, the user tracking activity information relating to a networked information system; and
calculating a property valuation adjustment factor for a particular property based on the user tracking activity information.

20. The machine-readable medium of claim 19, wherein the property valuation adjustment factor is used in determining a valuation for the particular property.
